(19) United States
(12) Patent Application Publication
(10) Pub. No.: US 2007/0054207 A1
(43) Pub. Date: Mar. 8, 2007

(54) Electrophotographic photoreceptor, image forming apparatus, and process cartridge

(76) Inventor: Michio Kimura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/508,267

(22) Filed: Aug. 23, 2006

(30) Foreign Application Priority Data
Aug. 23, 2005 (JP) 2005-240544

(51) Int. Cl. G03G 5/047

(52) U.S. Cl. 430/58.2; 430/59.6; 430/970; 399/159

(57) ABSTRACT

A photoreceptor is provided including an electroconductive substrate, and a charge transport layer located overlying the electroconductive substrate, wherein the charge transport layer includes a polydialkylsiloxane-containing polycarbonate resin having a specific formula, a charge transport material, and a cyclic ether solvent in an amount of from 20 to 5,000 ppm; and an image forming apparatus and a process cartridge, using the photoreceptor.

### BACKGROUND OF THE INVENTION

1. Field of the Invention

The present invention relates to an electrophotographic photoreceptor. The present invention also relates to an image forming apparatus and a process cartridge using the electrophotographic photoreceptor.

2. Discussion of the Background

Japanese Patent No. (herein after referred to as JP) 2714907 discloses an electrophotographic photoreceptor having a photosensitive layer including a copolymer resin of a bisphenol A-type polycarbonate and a biphenyl polycarbonate, and a hindered phenol and/or a hindered amine. It is described in JP 2714907 that such a photoreceptor has high sensitivity, high durability, and good mechanical strength.

Published unexamined Japanese Patent Application No. (herein after referred to as JP-A) 6-308749 discloses an electrophotographic photoreceptor having a charge transport layer including a copolymer resin of a bisphenol A-type polycarbonate and a biphenyl polycarbonate, and a specific charge transport material. It is described in JP-A 6-308749 that such a photoreceptor has high sensitivity, high durability, good crack resistance, and good ozone resistance.

JP-A 11-65136 discloses an electrophotographic photoreceptor having a photosensitive layer including a polydialkylsiloxane-containing polycarbonate as a binder resin. It is described in JP-A 11-65136 that by using such a photoreceptor, filming, black spots, and white spots hardly occur.

JP 3160773 discloses an image forming method in which a photoreceptor having an outermost layer including a copolymer resin of a bisphenol A-type polycarbonate and a biphenyl polycarbonate is cleaned with a cleaning blade made of an urethane rubber. It is described in JP 3160773 that cracks hardly appear in such a photoreceptor.

JP-A 11-130857 discloses an electrophotographic photoreceptor in which a photosensitive layer or an outermost protective layer thereof includes a polycarbonate resin including an organic group having a polysiloxane structure. It is described in JP-A 11-130857 that such a photoreceptor has good abrasion resistance and toner filming resistance.

JP-A 10-182832 discloses a polycarbonate resin modified by a specific polysiloxane. It is described in JP-A 10-182832 that such a polycarbonate resin has good moldability (i.e., releasability from metal mold), and a molding thereof has good releasability and water-shedding property.

JP-A 10-232503 discloses an electrophotographic photoreceptor including a polycarbonate resin modified by a specific polysiloxane. It is described in JP-A 10-232503 that such a photoreceptor has good mechanical strength, toner filming resistance, and electric property (because of having good compatibility with a charge transport material).

However, JP 2714907 and JP-A 6-308749 have not mentioned about solvent used for coating the charge transport layer. It seems that environmentally friendly cyclic ether solvents are not used in manufacturing the photoreceptors disclosed in these references.

JP-As 11-65136 and 11-130857 have also not mentioned about solvent used for coating the charge transport layer. In addition, no mention is made of photoreceptor belt and multilayer coating.

In the examples of JP 3160773, methylene chloride which causes an environmental damage is used as a solvent for coating the charge transport layer. A mention is made of gelatinization of the coating liquid, but no mention is made of tetrahydrofuran (THF).

JP-A 10-182832 does not disclose an application example of the electrophotographic photoreceptor to which the disclosed polycarbonate resin is applied. In addition, no mention is made of tetrahydrofuran (THF).

In the examples of JP-A 10-232503, methylene chloride which causes an environmental damage is used as a solvent for coating the charge transport layer. In addition, no mention is made of application of the photoreceptor to color image forming apparatus.

JP-A 2000-347518 discloses an image forming apparatus including an electrophotographic photoreceptor having a perimeter of Φd and an intermediate transfer medium having a perimeter of Φc, wherein the ratio Φc/Φd is a noninteger, and wherein the photoreceptor has a charge generation layer including a silicone oil. It is described in JP-A 2000-347518 that by using such a photoreceptor, the produced images have no color unevenness. However, in the examples of JP-A 2000-347518, halogen solvents which cause an environmental damage are used as solvents for coating the charge transport layer.

JP-A 2004-177560 discloses an electrophotographic photoreceptor having a charge transport layer including a polycarbonate copolymer having a siloxane skeleton as a binder resin. It is described in JP-A 2004-177560 that such a photoreceptor has smooth surface even if a leveling agent (such as silicone oils) is not used, and hardly increases the residual potential.

### SUMMARY OF THE INVENTION

Accordingly, an object of the present invention is to provide an electrophotographic photoreceptor which is environmentally friendly and which can produce high quality images over a long period of time under conditions of high temperature and high humidity without forming a toner film thereon.

Another object of the present invention is to provide an image forming apparatus and a process cartridge which can produce high quality images for a long period of time even under conditions of high temperature and high humidity.

These and other objects of the present invention, either individually or in combinations thereof, as hereinafter will become more readily apparent can be attained by a photoreceptor, comprising:

an electroconductive substrate; and

a charge transport layer located overlying the electroconductive substrate, wherein the charge transport layer comprises:
a polydialkylsiloxane-containing polycarbonate resin having the following formula (I): 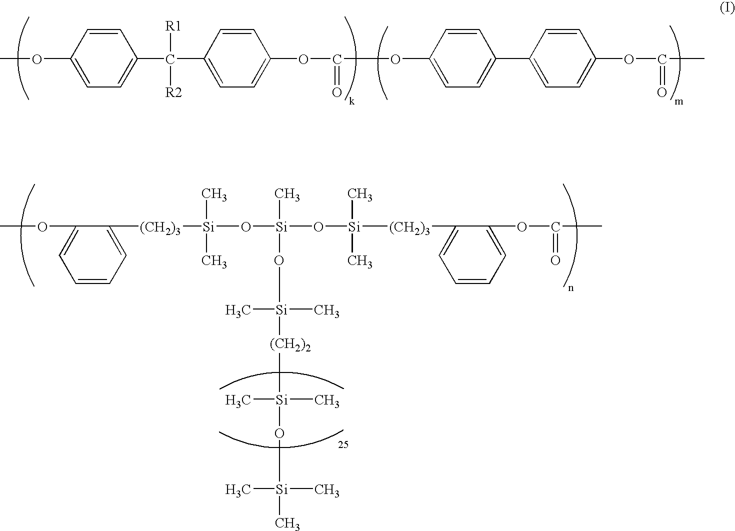
   wherein R1 and R2 each, independently, represents a hydrogen atom, a substituted or unsubstituted alkyl group having 1 to 6 carbon atoms, or a substituted or unsubstituted aryl group, wherein R1 and R2 optionally share bond connectivity to form a residue group of a cyclic hydrocarbon having 4 to 10 carbon atoms; and k represents a number of from 0.5 to 0.95, m represents a number of from 0.05 to 0.4999, and n represents a number of from 0.1 to 0.0001, wherein the sum of k, m and n is 1;
a charge transport material; and
a cyclic ether solvent in an amount of from 20 to 5,000 ppm;
   and an image forming apparatus and a process cartridge, using the photoreceptor.

In this regard, “overlying” can include direct contact and allow for intermediate layers.

### BRIEF DESCRIPTION OF THE DRAWINGS

These and other objects, features and advantages of the present invention will become apparent upon consideration of the following description of the preferred embodiments of the present invention taken in conjunction with the accompanying drawings, wherein:

FIG. 1 is a schematic view illustrating a cross-section of an embodiment of the photoreceptor of the present invention;

FIG. 2 is a schematic view illustrating an embodiment of the photoreceptor belt of the present invention; and

FIG. 3 is a schematic view illustrating an embodiment of the image forming apparatus of the present invention.

### DETAILED DESCRIPTION OF THE INVENTION

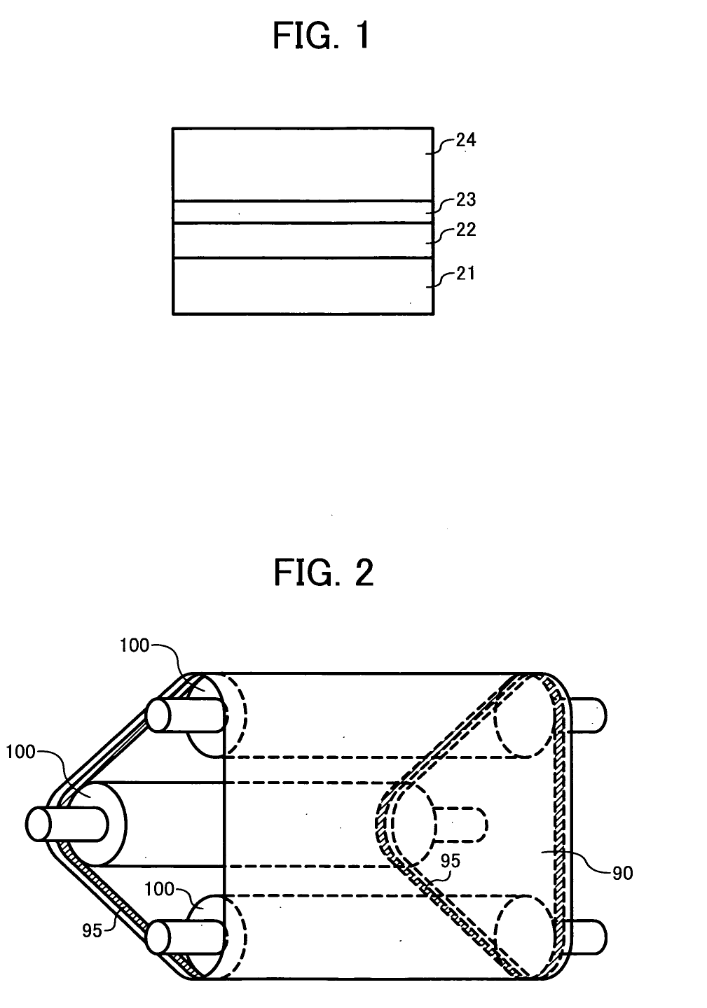

FIG. 1 is a schematic view illustrating a cross-section of an embodiment of the photoreceptor of the present invention. The photoreceptor includes a substrate 21, an undercoat layer 22, a charge generation layer 23, and a charge transport layer 24, wherein the layers 22, 23, and 24 are overlaid on the substrate 21 in this order. Optionally, a protective layer can be formed on the charge transport layer 24.

Substrate

Suitable materials for use in the substrate 21 include materials having a volume resistivity of not greater than 10¹⁰ Ω·cm. Specific examples of such materials include plastic films (e.g., polyethylene terephthalate, polybutylene terephthalate, phenol resin, polypropylene, nylon,polystyrene), on the surface of which a metal (e.g., aluminum, nickel, chromium, nichrome, copper, silver, gold, platinum, stainless) or a metal oxide (e.g., tin oxides, indium oxides, nickel oxides) is formed by deposition or sputtering; films and endless belts of a metal (e.g., nickel, stainless) formed by electroplating; films and endless belts of a molded plastic containing an electroconductive material therein; etc.

Furthermore, substrates in which a coating liquid including a binder resin and an electroconductive powder is coated on the substrates mentioned above can be used as the substrate 21. Specific examples of the electroconductive powders include carbon black, acetylene black, powders of metals (e.g., nickel, iron, nichrome, copper, zinc, silver), titanium black, metal oxides (e.g., electroconductive tin oxides, ITO), etc.

Specific examples of the binder resins include any known thermoplastic resins, thermosetting resins, and photo-crosslinking resins such as polystyrenes, styrene-acrylonitrile copolymers, styrene-butadiene copolymers, styrene-maleic anhydride copolymers, polyesters, polyvinyl chlorides, vinyl chloride-vinyl acetate copolymers, polyvinyl acetates, polyvinylidene chlorides, polyarylate resins, phenoxy resins, polycarbonates, cellulose acetate resins, ethylcellulose resins, polyvinyl butyrals, polyvinyl carbazoles, polyvinyl toluenes, poly-N-vinyl carbazoles, acrylic resins, silicone resins, epoxy resins, melamine resins, urethane resins, phenol resins, alkyd resins, and the like.

Such an electroconductive layer can be formed by coating a coating liquid in which an electroconductive powder and a binder resin are dispersed or dissolved in a proper solvent such as tetrahydrofuran, methyl ethyl ketone, toluene, and the like.

Nickel seamless belts can be used as the substrate. JPs 2913104 and 2620070, and published examined Japanese Patent Applications Nos. (hereinafter referred to as JP-B) 7-78639, 52-36016, and 52-8774 have disclosed methods for preparing a nickel seamless belt as follows. A cylindrical mandrel of which outer surface is made of a chromium or a stainless steel is rotating in an electroplating bath so as to be electroplated between an anode basket arranged around the cylindrical mandrel. Thus, a nickel seamless belt can be formed on the outer surface of the cylindrical mandrel.

When the nickel seamless belt is formed, a mandrel having a difference in perimeter between both ends (in the width direction of the belt) of from 0.05 to 0.31 mm is used, in order to easily release the nickel seamless belt therefrom. In other words, the mandrel has slightly conical shape. When the perimeter difference is too large, a strong forth is applied to only one side of the nickel seamless belt, and therefore a misalignment adjusting member runs upon a roller when the nickel seamless belt is used for a photoreceptor belt unit. As a result, feeding property of the photoreceptor belt deteriorates. In addition, irregular development and irregular transfer tend to be caused at a developing part and a transfer part, respectively. Moreover, corrugated unevenness is developed on the nickel seamless belt after long repeated use. When the perimeter difference is too small, it is extremely difficult to strip off the nickel seamless belt from the mandrel, and therefore kink (i.e., a bend of the belt) tends to be formed.

The outer surface of the cylindrical mandrel preferably has a surface roughness Rz of from 0.05 to 0.8 μm in order to easily release the nickel seamless belt from the mandrel.

The nickel seamless belt preferably has a thickness of from 26 to 36 μm when it is used as the substrate 21. When the thickness is too small, kink tends to be formed at the ends of the nickel seamless belt when plural rollers are put therein so as to assemble a photoreceptor unit. When the thickness is too large, the nickel seamless belt has too strong a stiffness and therefore it is difficult to be fed by a driving roller (i.e., feeding property deteriorates).

Undercoat Layer

The undercoat layer 22 is formed on the substrate 21 for the following purposes:
(1) preventing charge injection from the substrate;
(2) improving adhesion property to the substrate;
(3) preventing occurrence of moire;
(4) improving coating property of the upper layer; and
(5) decreasing residual potential.

The under coat layer 22 includes a resin as a main component, and optionally includes a powder of metal oxides (e.g., titanium oxide, silica, alumina, zirconium oxide, tin oxide, indium oxide), metal sulfides, metal nitrides, etc., and mixtures thereof. Among these, high-purity titanium oxides are preferably used.

It is preferable that the resins for use in the undercoat layer 22 are insoluble in typical organic solvents because photosensitive layers are coated thereon using organic solvents. Specific examples of such resins include thermoplastic resins such as polyamides, polyesters, vinyl chloride-vinyl acetate copolymers, and the like; and thermosetting resins such as heat polymerization products of (1) a compound having plural active hydrogens (such as a hydrogen atom of —OH group, —NH₂ group, —NH group, and the like) with (2) a compound having plural isocyanate groups and/or a compound having plural epoxy groups, and the like.

Specific examples of the compounds having plural active hydrogens include polyvinyl butyrals, phenoxy resins, phenol resins, polyamides, polyesters, acrylic resins having an active hydrogen (such as a hydrogen atom of hydroxyethyl methacrylate group), etc. Specific examples of the compounds having plural isocyanate groups include tolylene diisocyanate, hexamethylene diisocyanate, diphenylmethane diisocyanate, etc., and prepolymers thereof. Specific examples of the compounds having plural epoxy groups include bisphenol A-type epoxy resins, etc.

In addition, thermosetting resins prepared by heat polymerization of an oil-free alkyd resin with an amino resin (such as butylated melamine resins), and photo-crosslinking resins prepared by using a resin having an unsaturated bond (such as polyurethanes having an unsaturated bond and unsaturated polyesters) and a photo polymerization initiator (such as thioxanthone compounds and methylbenzyl formate), can be also used as a binder resin. These resins can be used alone or in combination. These resins are dissolved in a proper solvent to prepare a coating liquid. A powder of a metal oxide can be optionally included in the coating liquid, and is dispersed in the solvent together with the binder resin using a ball mill, a sand mill, an attriter, etc. The undercoat layer 22 can be formed on the substrate 21 by methods such as roll coating method, dip coating method, spray coating method, nozzle coating method, blade coating method, and the like.

After the coating liquid is coated on the substrate 21, the coated substrate is subjected to drying, or hardening upon application of heat or light. The undercoat layer 22 preferably has a thickness of from 0.1 to 30 μm, and more preferably from 0.2 to 10 μm. When a powder of a metal oxide is added to the undercoat layer, it is preferable that the volume ratio of the powder of the metal oxide to the binder resin is preferably 0.5/1 to 3/1.

Charge Generation Layer (CGL)

The charge generation layer 23 includes a charge generation material as a main component, and optionally includes a binder resin. The charge generation materials include inorganic materials and organic materials.

Specific examples of the inorganic materials include crystalline selenium, amorphous selenium, selenium-tellurium compounds, selenium-tellurium-halogen compounds, selenium-arsenic compounds, etc.

Specific examples of the organic materials include any known organic materials such as phthalocyanine pigments (e.g., metal phthalocyanine, metal-free phthalocyanine), azulenium salt pigments, squaric acid methyne pigments, azo pigments having a carbazole skeleton, azo pigments having a triphenylamine skeleton, azo pigments having a diphenylamine skeleton, azo pigments having a dibenzothiophene skeleton, azo pigments having a fluorenone skeleton, azo pigments having an oxadiazole skeleton, azo pigments having a bisstilbene skeleton, azo pigments having a distyryloxadiazole skeleton, azo pigments having a distyrylcarbazole skeleton, perylene pigments, anthraquinone and polycyclic quinone pigments, quinonimine pigments, diphenylmethane and triphenylmethane pigments, benzoquinone and naphthoquinone pigments, cyanine and azomethine pigments, indigoid pigments, bisbenzimidazole pigments, and the like. These charge generation materials can be used alone or in combination.

The azo pigments for use in the present invention preferably has the following formula (II): 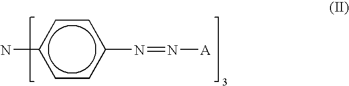
wherein A represents a residue group of a coupler having a phenolic hydroxyl group.

Specific examples of the azo pigments having the formula (II) include the following compounds (II-1) to (II-62).

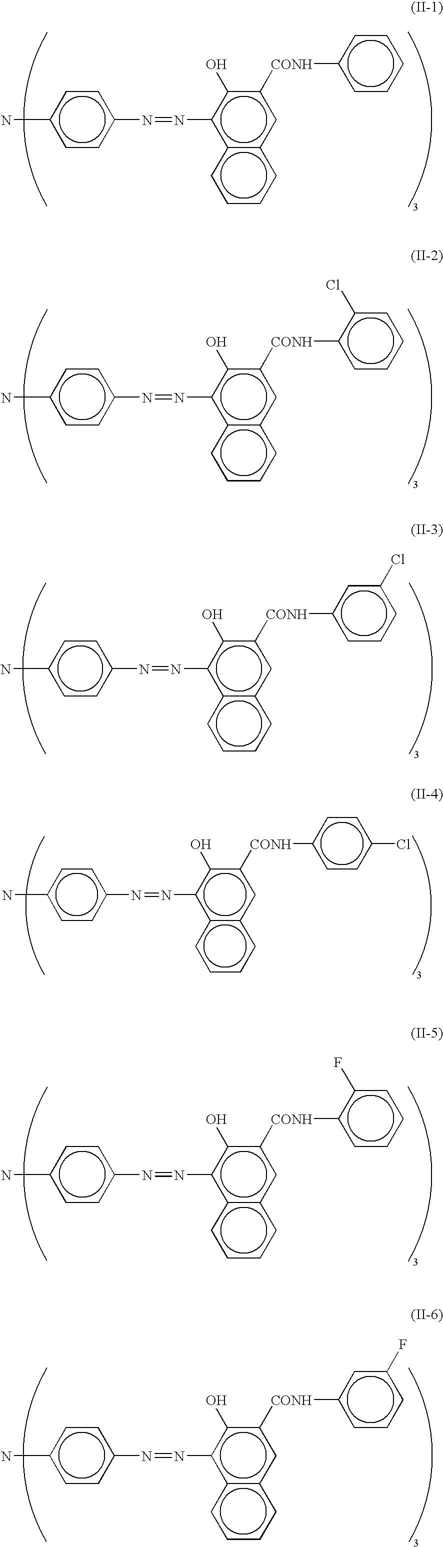

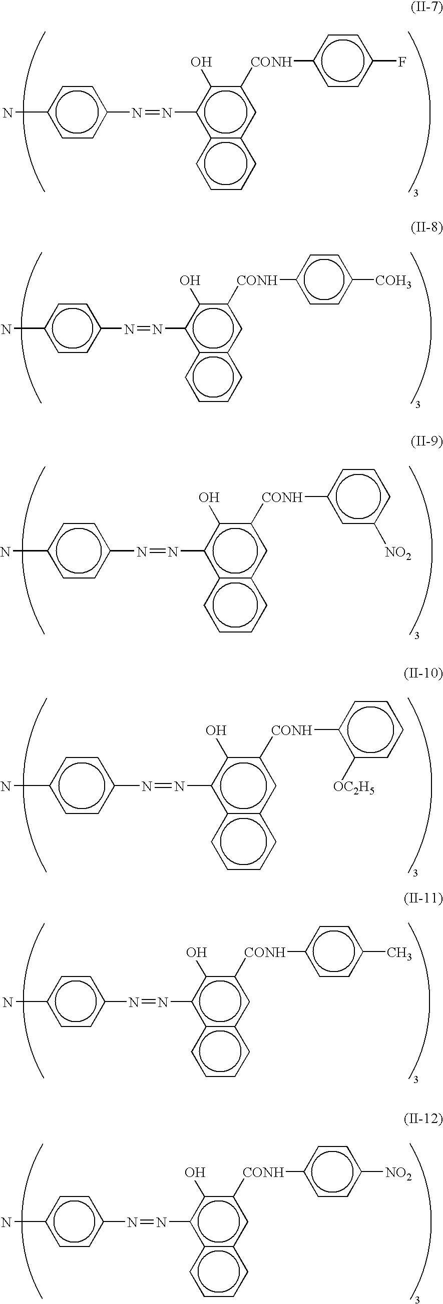

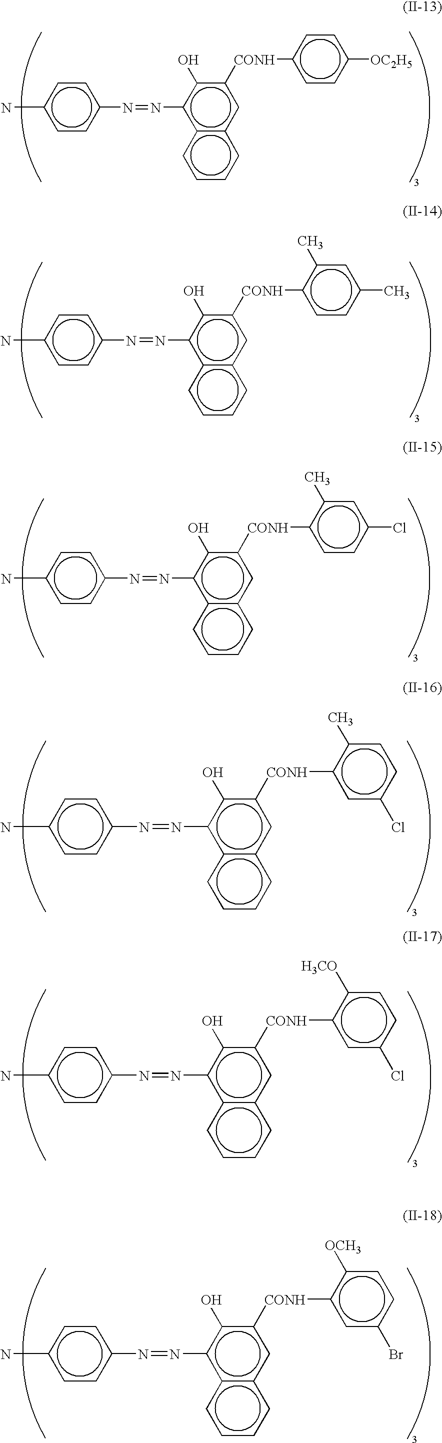

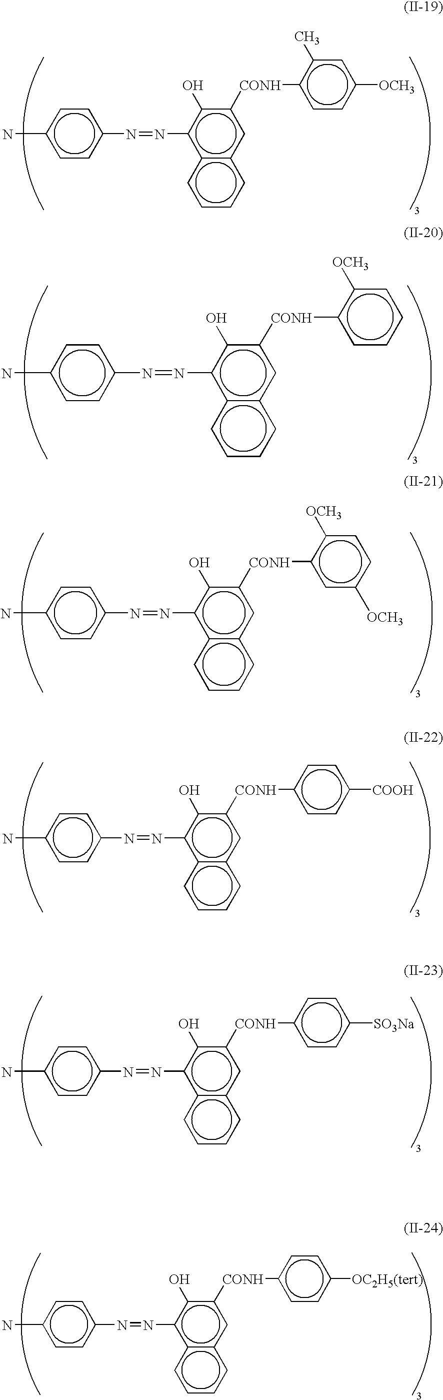

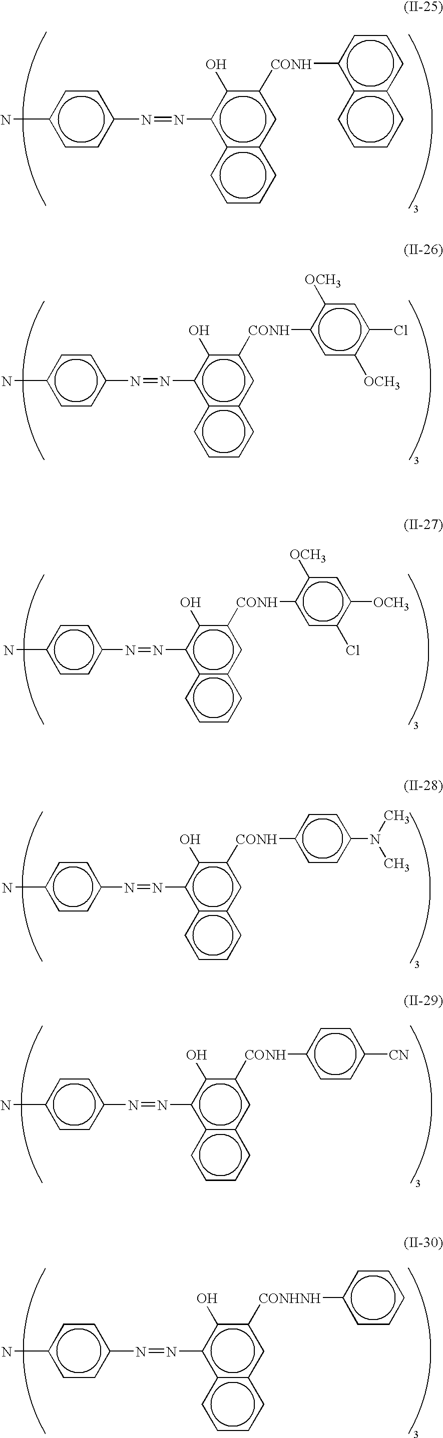

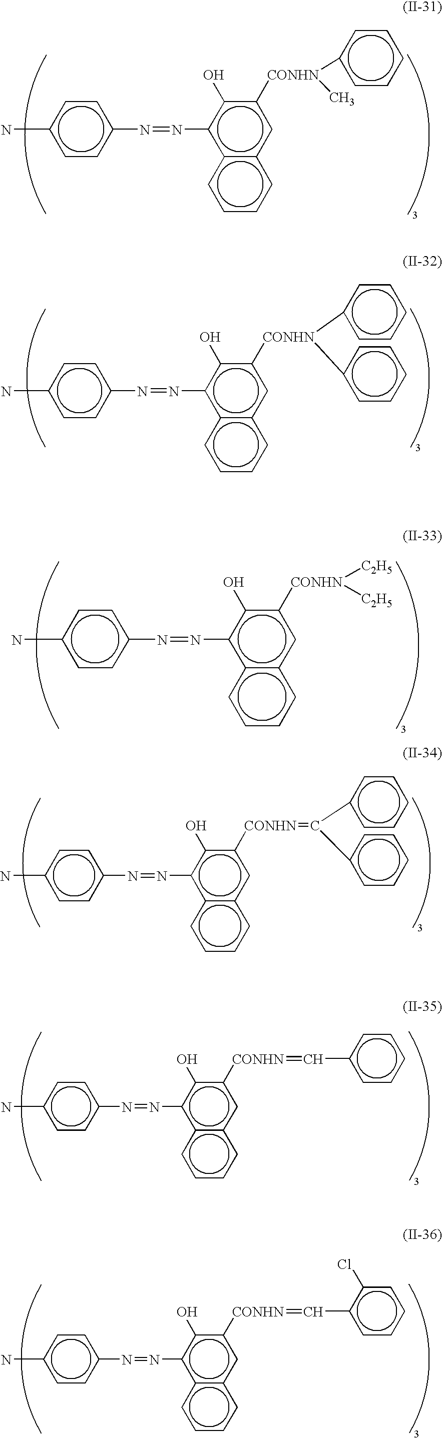

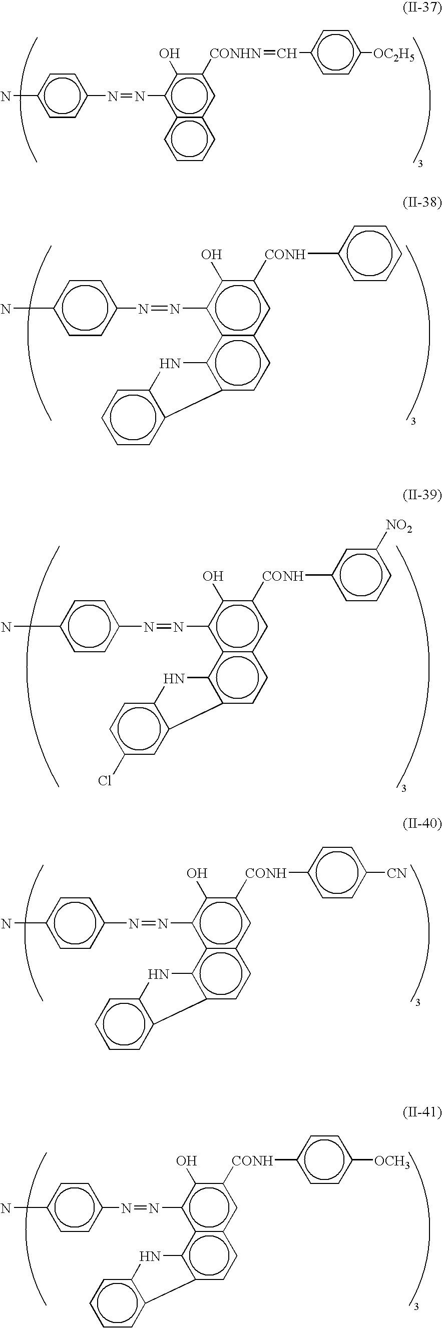

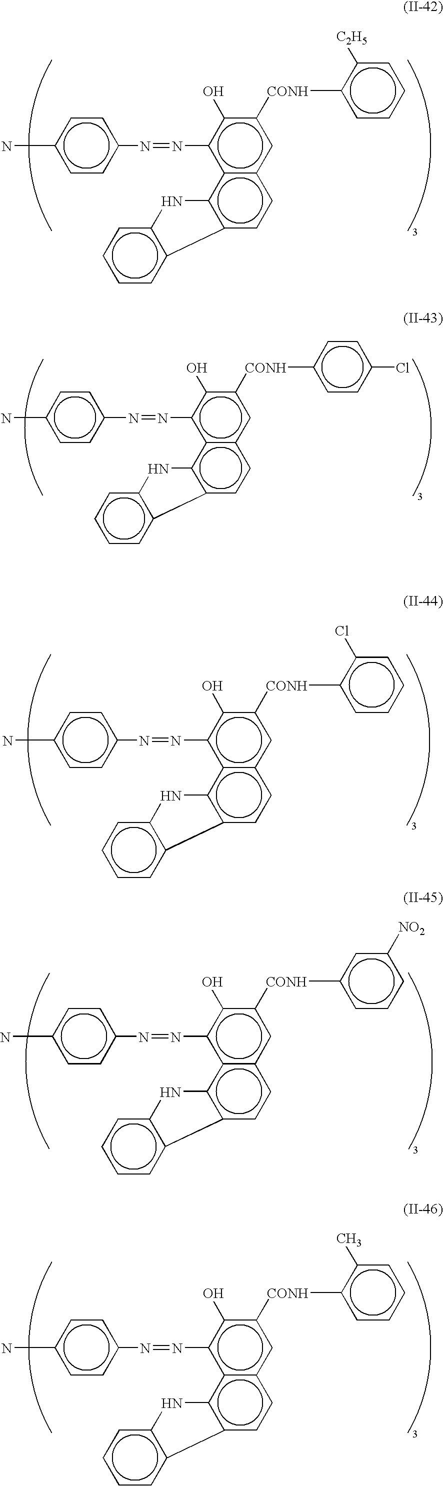

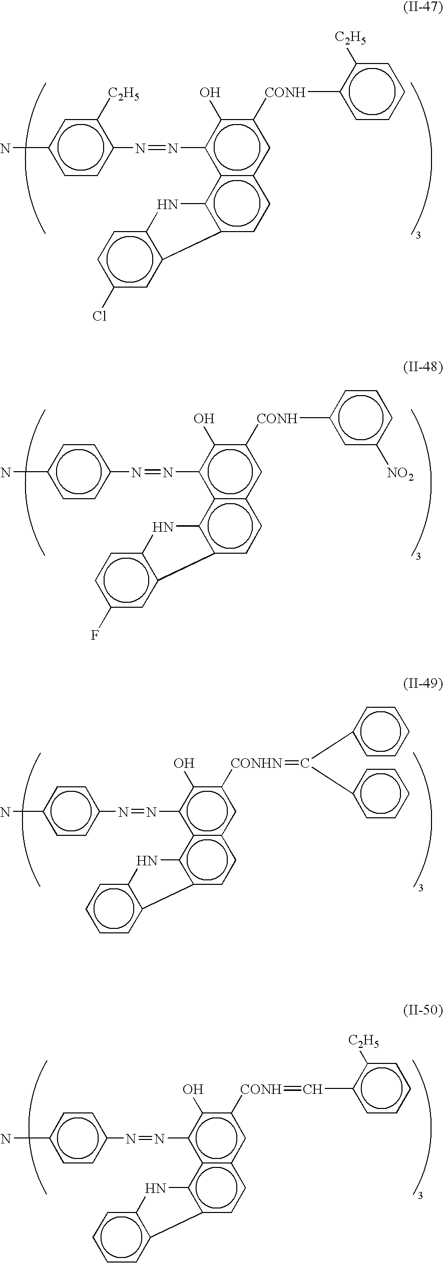

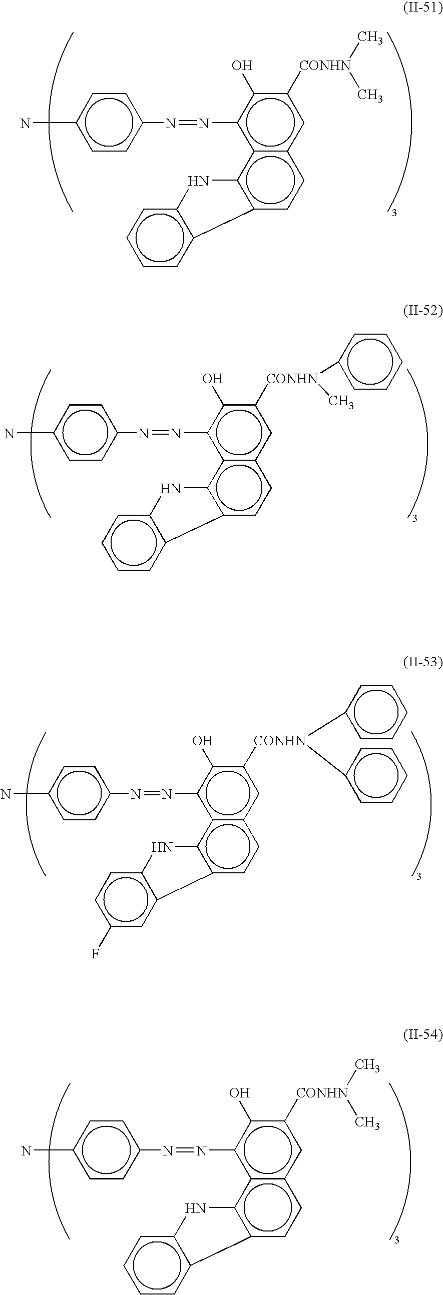

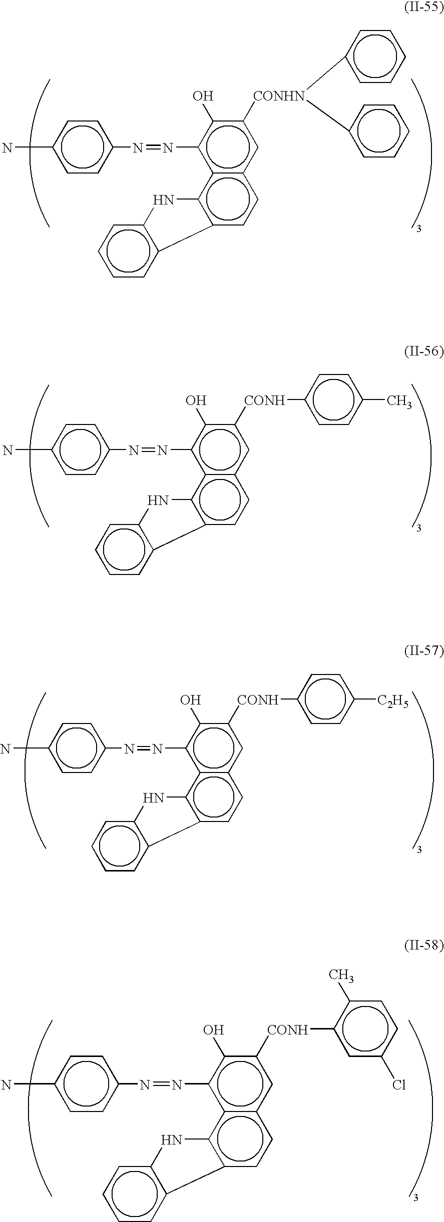

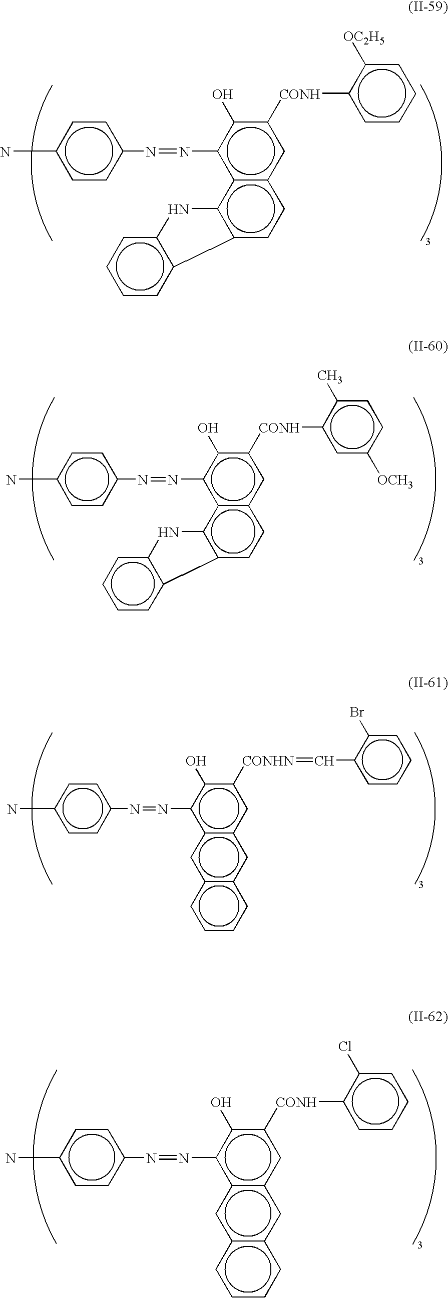

Specific examples of the binder resins, which are optionally included in the charge generation layer, include polyamides, polyurethanes, polyketones, polycarbonates, silicone resins, acrylic resins, polyvinyl butyrals, polyvinyl formals, polyvinyl ketones, polystyrenes, poly-N-vinylcarbazoles, polyacrylic amides, etc. These binder resins can be used alone or in combination.

The charge generation layer may optionally include a charge transport material. In addition to the above-mentioned binder resins, polymeric charge transport materials can be used as a binder resin of the charge generation layer.

The charge generation layer may optionally include a silicone oil having a viscosity of from 50 to 200 cP and the following formula: 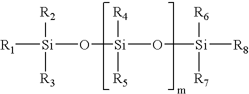
wherein R₁ to R₈ each, independently, represents an alkyl group. (such as methyl group and ethyl group), an aryl group (such as phenyl group), or an alkoxy group (such as methoxy group and ethoxy group), which may have a substituent group or a halogen atom; and m represents an integer.

When a charge generation layer coating liquid (i.e., after-mentioned dispersion liquid) includes such a silicone oil, the coating liquid can be uniformly coated, resulting in preventing occurrence of image density unevenness and color unevenness in the produced images. When the viscosity is too small, occurrence of color unevenness cannot be sufficiently prevented. When the viscosity is too large, the coating liquid is defectively coated, resulting in formation of cissing.

A weight ratio (P/R) between a charge generation material (P) and a resin (R) included in the charge generation layer 23 is preferably from 1/1 to 3/1. In this case, the adhesion between the photosensitive layer and the undercoat layer improves, and the potential after light irradiation is stable.

The charge generation layer 23 is typically formed by a casting method using a dispersion liquid. The dispersion liquid is prepared by dispersing an inorganic or organic charge generation material in a solvent (such as tetrahydrofuran, cyclohexanone, dioxane, dichloroethane, butanone, and the like), optionally together with a binder resin, using a ball mill, an attritor, a sand mill, etc. The dispersion liquid is diluted as appropriate. The dispersion liquid is coated by methods such as dip coating, spray coating, bead coating, and the like.

The charge generation layer preferably has a thickness of from 0.01 to 5 μm, and more preferably from 0.05 to 2 μm.

Charge Transport Layer (CTL)

The charge transport layer 24 has functions of keeping a charge, and transporting a charge generated in the charge generation layer 23 by irradiation of light. The charge transport layer 24 is required to have flexibility for use in seamless belt photoreceptor, and durability for repeated use. The preferred suitable charge transport layer 24 of the present invention is formed by coating a coating liquid in which a polydialkylsiloxane-containing polycarbonate resin having the following formula (I), a charge transport material, and 2 or more hydroquinone oxidation inhibitors are dissolved in a cyclic ether solvent such as tetrahydrofuran, tetrahydropyran, 1,4-dioxane, dioxolane, toluene, dimethoxymethane, and the like: `

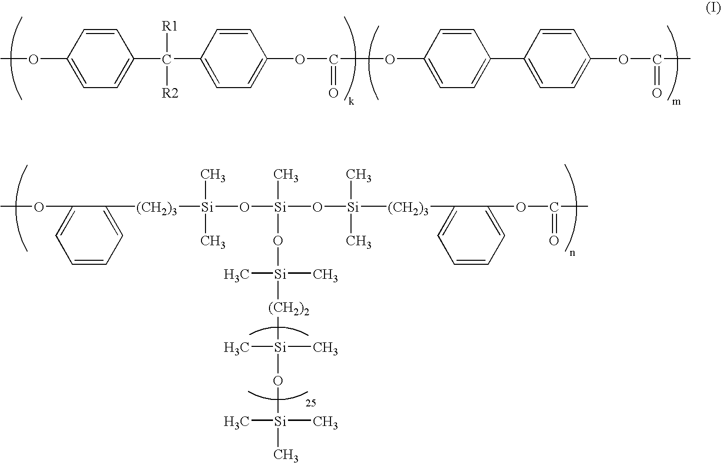
wherein R1 and R2 each, independently, represents a hydrogen atom, a substituted or unsubstituted alkyl group having 1 to 6 carbon atoms, or a substituted or unsubstituted aryl group, wherein R1 and R2 optionally share bond connectivity to form a residue group of a cyclic hydrocarbon having 4 to 10 carbon atoms; and k represents a number of from 0.5 to 0.95, m represents a number of from 0.05 to 0.4999, and n represents a number of from 0.1 to 0.0001, wherein the sum of k, m and n is 1;

Specific examples of binder resins which can be used in combination with the polydialkylsiloxane-containing polycarbonate resin having the formula (I) include polycarbonates (bisphenol A type and bisphenol Z type), polyesters, methacrylic resins, acrylic resins, polyethylenes, polystyrenes, phenol resins, silicone resins, polyvinyl carbazoles, polyvinyl butyrals, polyvinyl formals, polyacrylates, polyacrylamides, phenoxy resins, etc. The charge transport layer 24 preferably includes the above-mentioned binder resin in an amount of less than 50% by weight based on the total resin. A weight ratio (D/R) between a charge transport material (D) and a resin (R) included in the charge transport layer 24 is preferably from 0.5 to 1.2. When the ratio (D/R) is too small, the potential after light irradiation increases under low temperature conditions. When the ratio (D/R) is too large, the charge transport material is greatly abraded after repeated use of the photoreceptor.

The charge transport layer 24 optionally includes a plasticizer, a leveling agent, etc.

Specific examples of the leveling agents include silicone oils having a viscosity of from 50 to 1000 cP and the following formula: 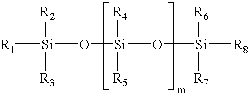
wherein R₁ to R₈ each, independently, represents an alkyl group (such as methyl group and ethyl group), an aryl group (such as phenyl group), or an alkoxy group (such as methoxy group and ethoxy group), which may have a substituent group or a halogen atom; and m represents an integer.

It is more preferable that the leveling agent is a silicone oil which is a same kind as the silicone oil added in the charge generation layer. In this case, blurred images are hardly produced even after repeated use under conditions of high temperature and high humidity. In addition, image density hardly decreases even if the photoreceptor is left immediately under the charger. When the charge transport layer includes no silicone oil, the produced characters tend to be bold when the photoreceptor is left under conditions of high temperature and high humidity.

Suitable solvents for use in the charge transport layer coating liquid include cyclic ether solvents. These solvents can improve the adhesion between the photosensitive layer and the substrate or the undercoat layer. On the other hand, chlorinated solvents (e.g., dichloromethane, chloroform, monochlorobenzene, trichloroethane, trichloromethane) are not used because these solvents are not environmentally friendly.

The charge transport layer 24 preferably includes a residual cyclic ether solvent in an amount of from 20 to 5,000 ppm. When the amount is too small, the adhesion between the photosensitive layer and the substrate or the undercoat layer decreases. When the amount is too large, the potential after light irradiation increases. The amount of the residual cyclic ether solvent can be controlled by changing drying conditions of the charge transport layer.

The polydialkylsiloxane-containing polycarbonate resin having the formula (I) preferably has a viscosity average molecular weight of from 30,000 to 80,000 for use in seamless belt photoreceptor. When the viscosity average molecular weight is too small, microcracks tend to be appeared on the photoreceptor after repeated use. When the viscosity average molecular weight is too large, the coating liquid cannot be well applied thereto. For example, coated layers tend to shrink at a time of drying.

In addition, the polydialkylsiloxane-containing polycarbonate resin having the formula (I) has good resistance to fingerprints, and able to decrease the torque of the cleaning blade.

Such a copolymer compound (i.e., the polydialkylsiloxane-containing polycarbonate resin having the formula (I)) can be prepared by the following method. In the presence of an inert solvent (such as methylene chloride and 1,2-dichloroethane), an acid acceptor (such as alkaline solutions and pyridine) is added to a mixture of a bisphenol and a biphenyl monomer, and subjected to a reaction while introducing phosgene. The detailed method is described in the examples of JP-A 10-182832.

When the cyclic ether solvent for use in the coating liquid of the charge transport layer 24 includes a phenolic oxidation inhibitor, the production of peroxides in the cyclic ether solvent is prevented, resulting in increasing a life of the coating liquid.

Specific examples of monophenolic compounds include 2,6-di-t-butyl-p-cresol, butylated hydroxyanisol, 2,6-di-t-butyl-4-ethylphenol, stearyl-β-(3,5-di-t-butyl-4-hydroxyphenyl) propionate, 3-t-butyl-4-hydroxyanisole, etc.

Specific examples of bisphenolic compounds include 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), etc.

Specific examples of polymeric phenolic compounds include 1,1,3-tris-(2-methyl-4-hydroxy-5-t-butylphenyl)butane, 1,3,5-trismethyl-2,4,6-tris(3,5-di-t-butyl-4-hydroxybenzyl) benzene, tetrakis[methylene-3-(3 ′, 5′-di-t-butyl-4′-hydroxyphenyl) propionate]methane, bis[3,3′-bis.(4′-hydroxy-3′-t-butylphenyl)butyric acid] glycol ester, tocophenols, etc.

Specific preferred examples of suitable phenolic oxidation inhibitors include the following compounds (III-1) to (III-7).

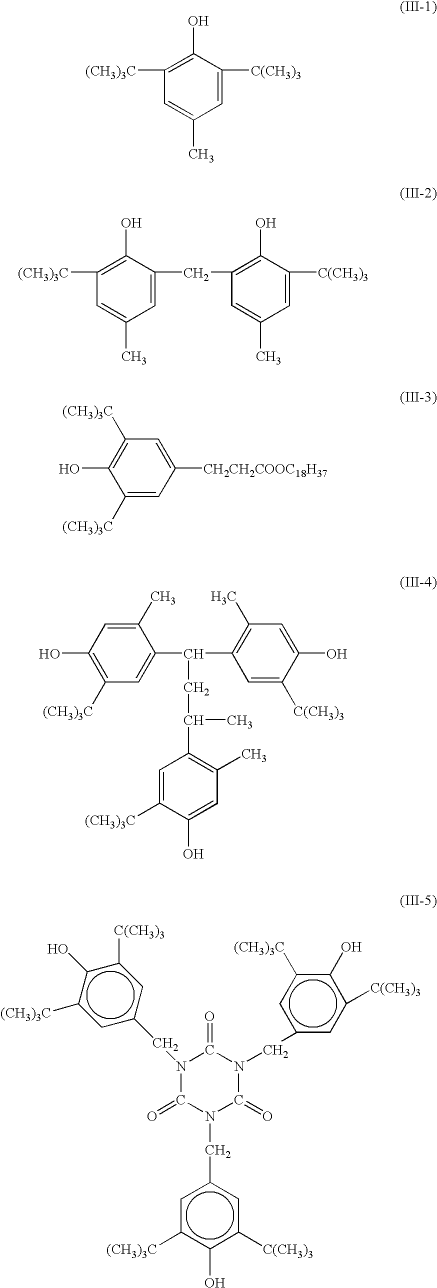

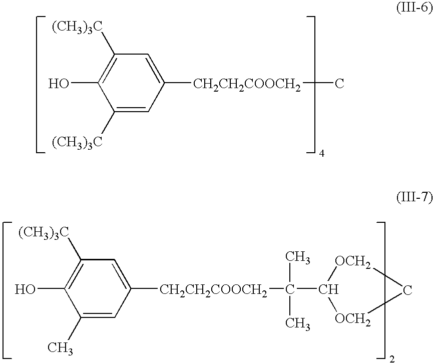

When the charge transport layer includes plural, preferably 2 or 3, kinds of hydroquinone oxidation inhibitors, the photoreceptor has stable charging property for a long period of time even after long repeated use. In addition, cyclic ether solvents having an unstable structure (such as tetrahydrofuran) can be stabilized.

Specific examples of the hydroquinone compounds include hydroquinone, methyl hydroquinone, 2,3-dimethyl hydroquinone, 2,5-dimethyl hydroquinone, 2,6-dimethyl hydroquinone, trimethyl hydroquinone, tetramethyl hydroquinone, tert-butyl hydroquinone, 2,5-di-tert-butyl hydroquinone, 2,5-di-tert-amyl hydroquinone, 2,5-diamyl hydroquinone, 1,4-diol naphthalene, octyl hydroquinone, dodecyl hydroquinone, chloro hydroquinone, 2,5-di-tert-octyl hydroquinone, 2,6-di-n-dodecyl hydroquinone, 2-n-dodecyl hydroquinone, 2-n-dodecyl-5-chloro hydroquinone, 2-tert-octyl-5-methyl hydroquinone, 2-tert-butyl-5-methyl hydroquinone, 2-(2-octadecyl) -5-methyl hydroquinone, 9,10-diol anthracene, etc.

Hydroquinone derivatives having the following formula (IV) are preferably used because these can be stably kept in the photosensitive layer without sublimation at a time of drying and preservation. 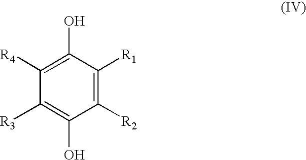
wherein R₁, R₂, R₃, and R₄ each, independently, represents a hydrogen atom, a halogen atom, a substituted or unsubstituted alkyl group, a substituted or unsubstituted alkenyl group, a substituted or unsubstituted aryl group, a substituted or unsubstituted cycloalkyl group, a substituted or unsubstituted alkoxy group, a substituted or unsubstituted aryloxy group, an alkylthio group, an arylthio group, an alkylamino group, an arylamino group, an acyl group, an alkylacylamino group, an arylacylamino group, an alkylcarbamoyl group, an arylcarbamoyl group, an alkylsulfoneamine group, an arylsulfoneamine group, an alkylsulfamoyl group, an arylsulfamoyl group, an alkylsulfonyl group, an arylsulfonyl group, an alkyloxycarbonyl group, an aryloxycarbonyl group, an alkylacyloxy group, an arylacyloxy group, a silyl group, or a heterocyclic group, wherein at least one of R₁, R₂, R₃, and R₄ has 4 or more carbon atoms.

Specific examples of the compounds having the formula (IV) include the following compounds (IV-1) to (IV-60).

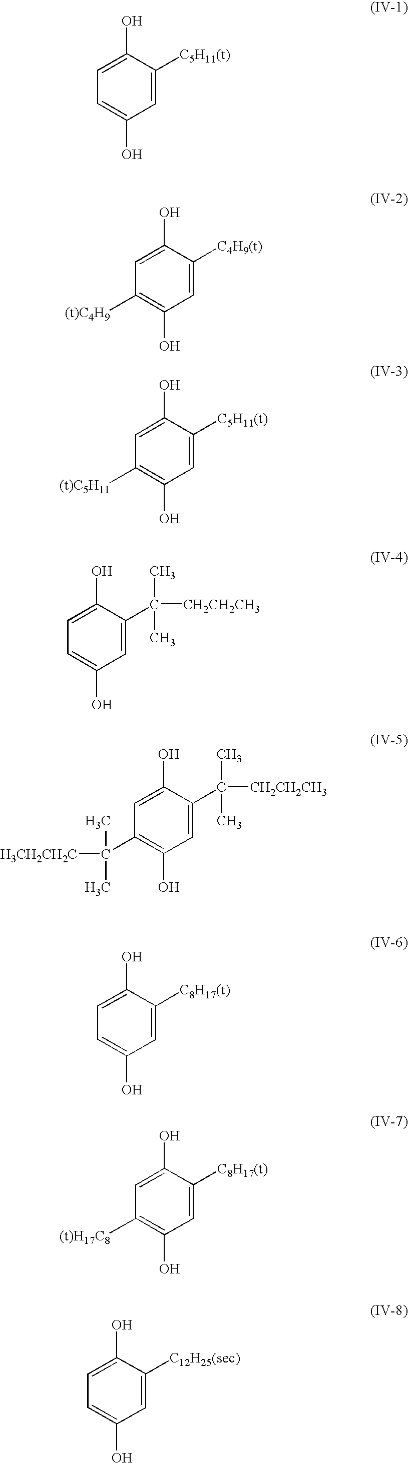

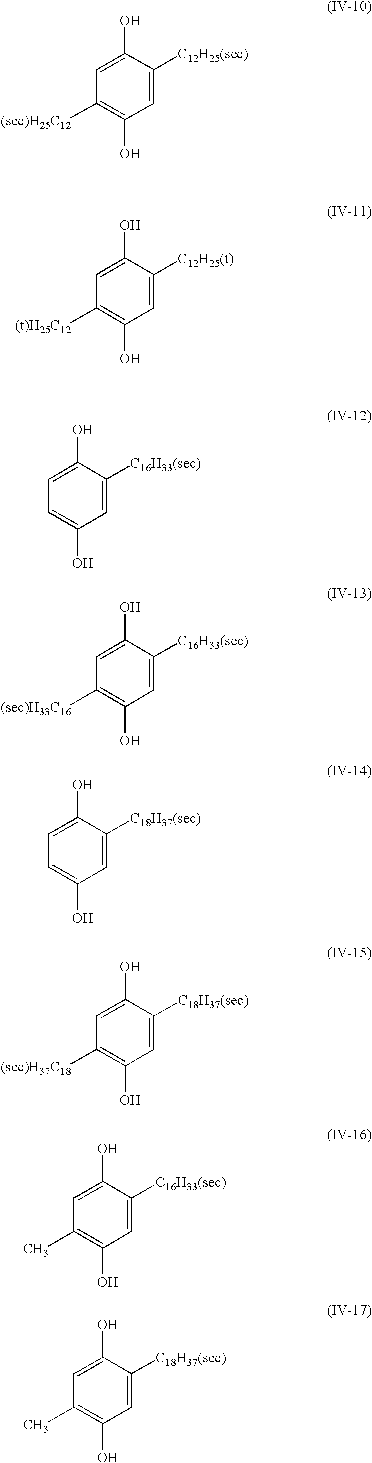

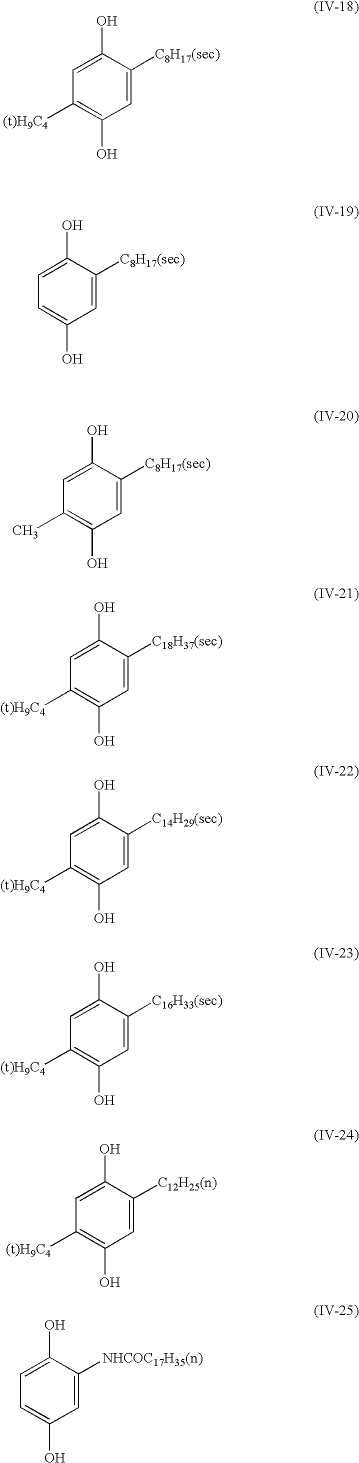

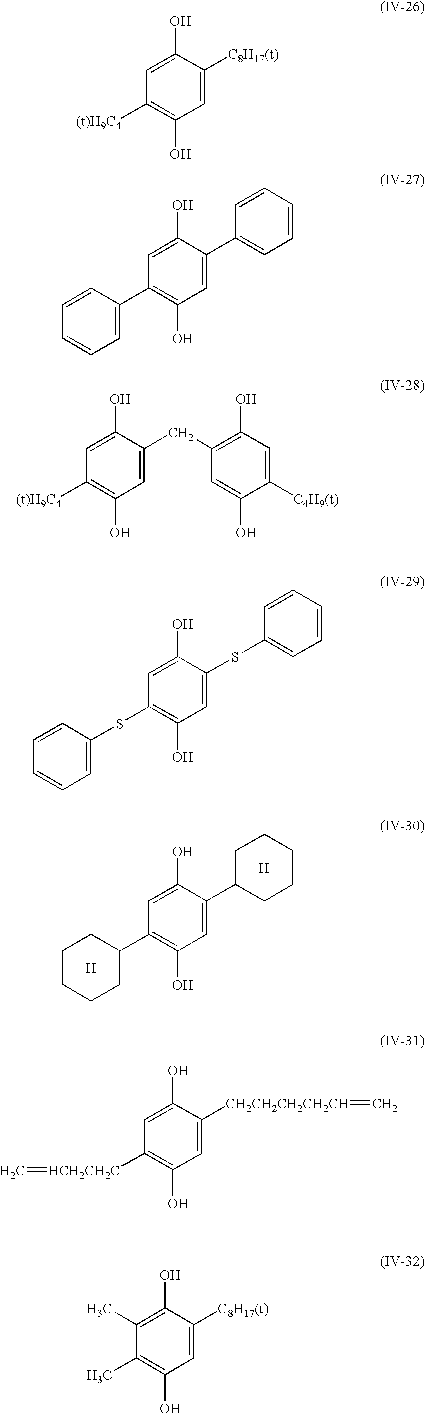

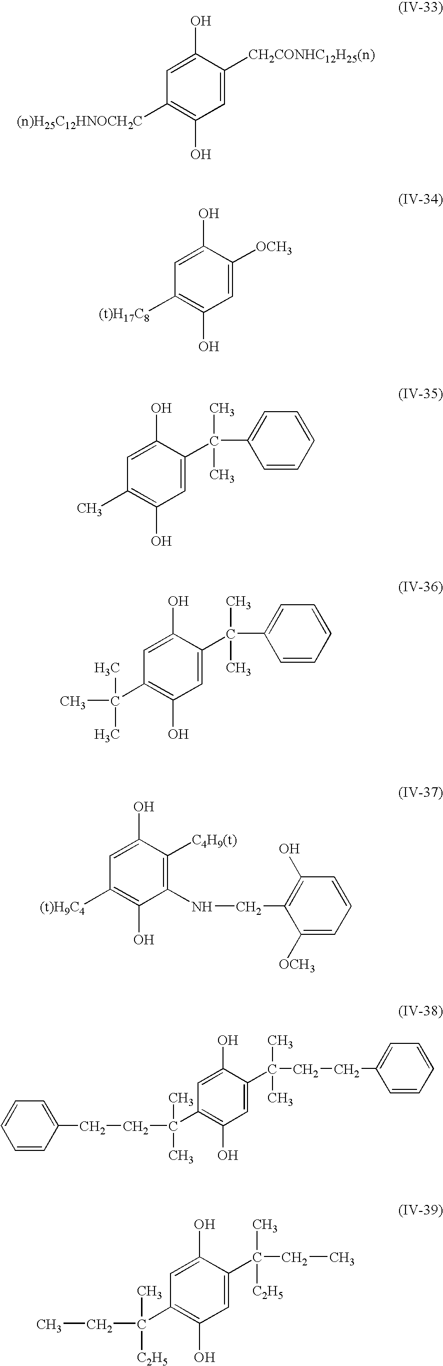

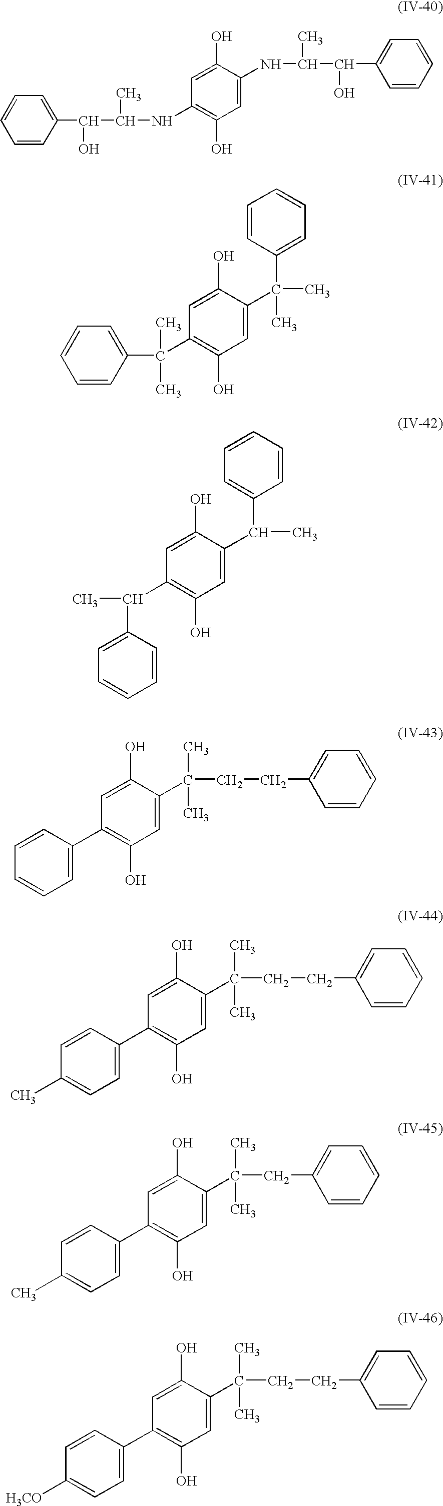

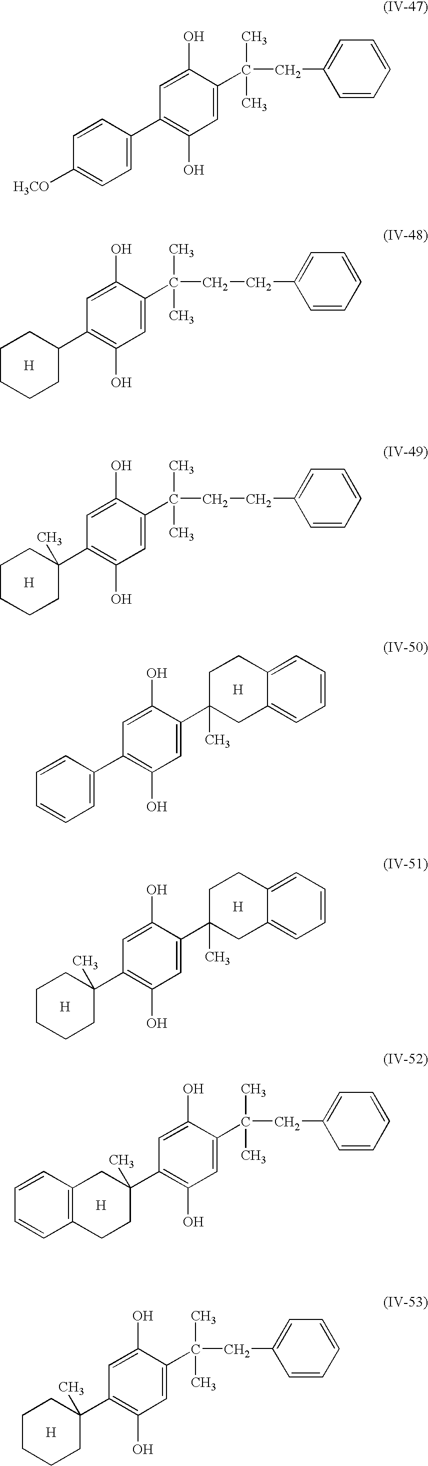

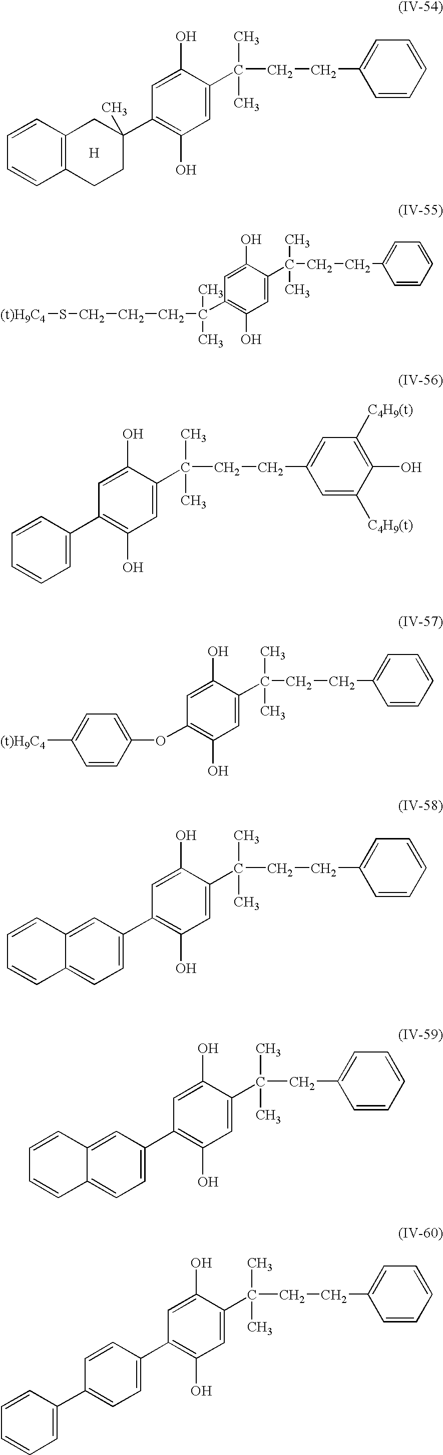

The charge transport layer 24 includes the hydroquinone oxidation inhibitor in an amount of from 0.05 to 5% by weight based on the charge transport material. In this case, even after the photosensitive layer is abraded under strong electric field, background fouling hardly occurs. In particular, that is effective when the charge generation material is an azo pigment.

Charge transport materials are classified into electron transport materials and positive-hole transport materials.

Specific examples of the electron transport materials include electron accepting materials such as chloranil, bromanil, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-4H-indeno[1,2-b]thiophene-4-one, 1,3,7-trinitrodibenzothiophene-5,5-dioxide, and the like. These electron transport materials can be used alone or in combination. In addition, oxidation inhibitors such as monophenolic compounds excepting hydroquinone compounds, polymeric phenolic compounds, p-phenylenediamines, organic sulfur compounds, organic phosphorous compounds, and the like, can be used in combination.

Specific examples of the p-phenylenediamines include N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, N,N′-dimethyl-N,N′-di-t-butyl-p-phenylenediamine, etc.

Specific examples of the organic sulfur compounds include dilauryl-3,3′-thiodipropionate, distearyl-3,3′-thiodipropionate, ditetradecyl-3,3′-thiodipropionate, etc.

Specific examples of the organic phosphorous compounds include triphenylphosphine, tri(nonylphenyl)phosphine, tri(dinonylphenyl)phosphine, tricresylphosphine, tri(2,4-dibutylphenoxy)phosphine, etc.

Specific examples of the positive-hole transport materials include electron donating materials such as oxazole derivatives, oxadiazole derivatives, imidazole derivatives, triphenylamine derivatives, 9-(p-diethylaminostyrylanthracene), 1,1-bis-(4-dibenzylaminophenyl)propane, styrylanthracene, styrylpyrazoline, phenylhydrazones, α-phenylstilbene derivatives, thiazole derivatives, triazole derivatives, phenazine derivatives, acridine derivatives, benzofuran derivatives, benzimidazole derivatives, thiophene derivatives, an the like. These positive-hole transport materials can be used alone or in combination.

The charge transport layer 24 preferably has a thickness of from 5 to 100 μm.

Specific examples of the plasticizers include any known plasticizers such as dibutyl phthalate, dioctyl phthalate, bisbenzyl benzene derivatives, and the like. The content of the plasticizer is preferably from 0 to 30 parts by weight, based on 100 parts of the binder resin.

Specific examples of the leveling agents include silicone oils (e.g., dimethyl silicone oil, methylphenyl silicone oil), polymers or oligomers having a branched chain including a perfluoroalkyl group, etc. The content of the leveling agents is preferably from 0 to 1 parts by weight.

Protective Layer

A protective layer can be optionally formed on the charge transport layer 24.

The protective layer includes a binder resin, and a fine powder of a metal or a metal oxide is dispersed therein. Suitable binder resins for use in the protective layer is preferably transparent to visible and infrared light and has good electric insulation, mechanical strength, and adhesion property.

Specific examples of the binder resins for use in the protective layer include ABS resins, ACS resins, olefin-vinyl monomer copolymers, chlorinated polyethers, allyl resins, phenol resins, polyacetals, polyamides, polyamideimides, polyacrylates, polyallylsulfones, polybutylenes, polybutylene terephthalates, polycarbonates, polyether sulfones, polyethylenes, polyethylene terephthalates, polyimides, acrylic resins; polymethylpentenes, polypropylenes, polyphenylene oxides, polysulfones, polystyrenes, AS resins, butadiene-styrene copolymers, polyurethanes, polyvinyl chlorides, polyvinylidene chlorides, epoxy resins, etc.

Specific examples of the metal oxides include titanium oxide, tin oxide, potassium titanate, TiO, TiN, zinc oxide, indium oxide, antimony oxide, etc.

In order to improve durability, the protective layer may optionally include fluorocarbon resins (e.g., polytetrafluoroethylene), silicone resins, and these resins in which an inorganic material is dispersed therein, etc.

The protective layer is formed by typical coating methods. The protective layer preferably has a thickness of from 0.1 to 10 μm.

Photoreceptor Belt

FIG. 2 is a schematic view illustrating an embodiment of the seamless belt photoreceptor of the present invention.

Misalignment adjusting member 95 are arranged on both ends of the backside of a seamless belt 90. The seamless belt 90 is tightly stretched by plural rollers 100 and is moved endlessly. At least one of plural rollers 100 is a hair implant roller. Since the seamless belt 90 has a difference in perimeter between both ends of from 0.05 to 0.31 mm, the hair implant roller can absorb such a difference, and prevent occurrence of misalignment of the seamless belt 90. In addition, even if the hair implant roller produce abrasion powders after the repeated use, these can be buried in the hair, and therefore the backside of the seamless belt 90 is hardly worn.

Each of the rollers 100 preferably has an external diameter of 15 mm or more, and more preferably 30 mm. When the external diameter is too small, the stretched seamless belt 90 tends to be curled.

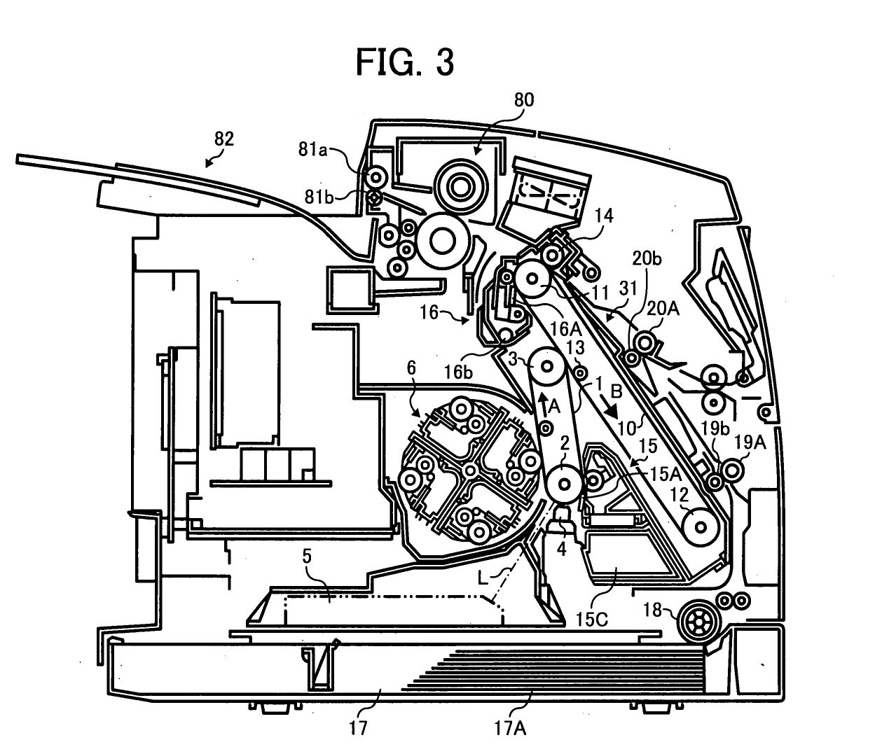

Image Forming Apparatus FIG. 3 is a schematic view illustrating an embodiment of the image forming apparatus of the present invention.

A photoreceptor belt 1 including a seamless belt is tightly stretched by rotative rollers 2 and 3, and is endlessly moved in the direction indicated by an arrow A (i.e., clockwise direction) due to the rotation of the rotative roller 2. A charger 4 configured to uniformly charge the surface of the photoreceptor belt 1, a laser writing unit 5 configured to irradiate the surface of the photoreceptor belt 1 and form an electrostatic latent image thereon, and a revolving developing device 6 including an yellow developing unit, a magenta developing unit, a cyan developing unit, and a black developing unit are arranged around the photoreceptor belt 1.

An intermediate transfer belt. 10 is tightly stretched by rotative rollers 11 and 12, and is endlessly moved in the direction indicated by an arrow B (i.e., counterclockwise direction) due to the rotation of the rotative roller 11. The intermediate transfer belt 10 contacts the photoreceptor belt 1 at a portion the rotative roller 3 is arranged backside thereof. At the backside of the contact portion of the intermediate transfer belt 10, a bias roller 13 having conductivity contacts the backside of the intermediate transfer belt 10 under a specific condition.

The photoreceptor belt 1 serving as an image bearing member is uniformly charged by the charger 4, and is exposed to a laser beam L emitted by the laser writing unit 5 based on image information to be formed an electrostatic latent image thereon. The image information is single color information obtained by color separating of a target full color image. The laser beam L generated by a semiconductor laser (not shown) is scanned and adjusted an optical path by an optical device (not shown).

Each of the single-color electrostatic latent images (yellow, cyan, magenta, and black) formed on the photoreceptor belt 1 is respectively developed with a yellow toner, a cyan toner, a magenta toner, and a black toner. Each of the single-color toner images is formed on the photoreceptor belt 1 one by one.

Each of the single-color toner images (yellow, cyan, magenta, and black) formed on the photoreceptor belt 1 rotating in the direction indicated by the arrow A is respectively transferred and overlaid on the intermediate transfer belt 10 rotating in synchronized with the photoreceptor belt 1 in the direction indicated by the arrow B, due to a transfer bias applied to the bias roller 13.

The intermediate transfer belt 10 is twice as long as the photoreceptor belt 1, and is strictly position-controlled so that a predetermined portion of the intermediate transfer belt 10 always contacts the same portion of the photoreceptor belt 1.

The overlaid toner image formed on the intermediate transfer belt 10 is transferred onto a transfer paper 17A, which is fed to a transfer region from a paper feed cassette 17 by a paper feed roller 18, a pair of transport rollers 19A and 19B, and a pair of registration rollers 20A and 20B, by a transfer roller 14. The overlaid toner image is fixed on the transfer paper 17A with a fixing device 80 to form a full-color image, and is discharged to a paper stacking part 82 by a pair of paper ejection rollers 81a and 81b.

A cleaning device 15 includes a cleaning blade 15A and a waste toner container 15C. The cleaning blade 15A always contacts the photoreceptor belt 1 so as to remove toner particles remaining thereon. A cleaning blade 16A included in a cleaning device 16 is kept away from.the surface of the intermediate transfer belt 10 while an image forming operation is performed, and contacts the surface of the intermediate transfer belt 10 after the formed image is transferred onto the transfer paper 17A.

The cleaning device 15 further includes a bar consisting of a metal salt of stearic acid, and a brush. By uniformly applying the metal salt of stearic acid to the surface of the photoreceptor belt 1, reproducibility of half-tone and line images, and image density of solid images improve, and abnormal images (such as wormhole) are not produced.

Specific examples of the metal salts of stearic acid include zinc stearate, calcium stearate, magnesium stearate, strontium stearate, etc.

Waste toner particles removed from the surface of the intermediate transfer belt 10 by the cleaning blade 16A are transported to the front side of the figure by an auger 16B included in the transfer belt cleaning device 16, and then transported to the waste toner container 15C by a transport member (not shown) arranged on a front side of a process cartridge 31. The waste toner container 15C is detached from the process cartridge 31 and replaced with a new one when a predetermined amount of waste toner particles fill the waste toner container 15C. Thereby, a life of the process cartridge 31 can be lengthened.

The photoreceptor belt 1, the charger 4, the intermediate transfer belt 10, the cleaning devices 15 and 16 are included in the process cartridge 31. The waste toner container 15C can be detached from the process cartridge 31 and replaced with a new one. An outer covering of the process cartridge 31 on which the registration roller 20B is arranged also has a function of a paper feed guide. By using the process cartridge, the image forming apparatus can be minimized. In addition, the process cartridge can be easily attached to/detached from the image forming apparatus.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

Formation of Undercoat Layer

The following components were fed to a ball mill pot and subjected to a dispersion treatment for 72 hours using aluminum balls having a diameter of 10 mm, to prepare an undercoat layer coating liquid.

| | | |
|---|---|---|
| Titanium oxide | 50 | parts |
| (CR-60 manufactured by Ishihara Sangyo Kaisha, Ltd.) | | |
| Alkyd resin | 15 | parts |
| (BECKOLITE ® M6401-50 manufactured | | |
| by Dainippon Ink and | | |
| Chemicals, Incorporated, solid content of 50% by weight) | | |
| Melamine resin | 8.3 | parts |
| (SUPER BECKAMINE ® L-121-60 | | |
| manufactured by Dainippon Ink and | | |
| Chemicals, Incorporated, solid content of 60% by weight) | | |
| Methyl ethyl ketone | 31.7 | parts |
| (manufactured by Kanto Chemical Co., Inc.) | | |

The thus prepared undercoat layer coating liquid was coated on a nickel seamless belt having a diameter of 92 mm, a length of 410 mm, a difference in perimeter between both ends of 0.1 mm, and a thickness of 30μ, by a dip coating method and dried for 20 minutes at 130° C. to prepare an undercoat layer having a thickness of 4.5 μm.

Formation of CGL

The following components were fed to a ball mill pot and subjected to a dispersion treatment for 72 hours using YTZ balls having a diameter of 10 mm.

| | |
|---|---|
| Charge generation material having the formula (II-42) | 2.4 parts |
| (manufactured by Ricoh Co., Ltd.) | |
| 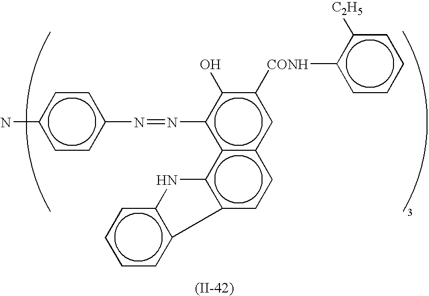 | |
| Charge generation material having the following formula (V) | 0.6 parts |
| (manufactured by Ricoh Co., Ltd.) | |
| 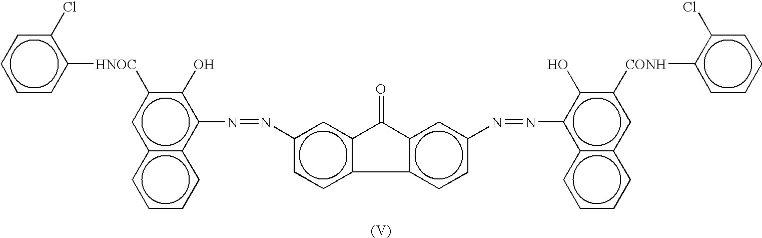 | |
| Cyclohexanone | 80 parts |
| (manufactured by Kanto Chemical Co., Inc.) | |

Next, 78.4 parts of cyclohexanone was further added thereto, and the mixture was subjected to a dispersion treatment for 2 hours. Further, 60 parts of a cyclohexanone solution (solid content of 2% by weight) of a polyvinyl butyral resin (having 33% by mole of hydroxyl group, and 64% by mole of butyral group) and 88.9 parts of methyl ethyl ketone were added thereto. Thus, a CGL coating liquid was prepared.

The CGL coating liquid was coated on the undercoat layer by a dip coating method and dried for 20 minutes at 130° C. to prepare a charge generation layer having a thickness of 0.07 μm.

Formation of CTL

The following components were mixed to prepare a CTL coating liquid.

| | |
|---|---|
| Charge transport material having the following formula (VI) | 7 parts |
| (manufactured by Ricoh Co., Ltd.) | |
| 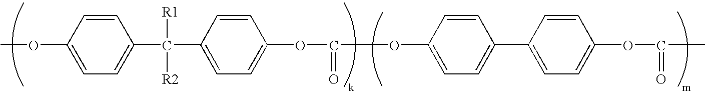 | |
| Polycarbonate resin having the formula (I) | 10 parts |
| (viscosity average molecular weight of 46,000, k = 0.85, | |
| m = 0.149, and n = 0.001) | |
| 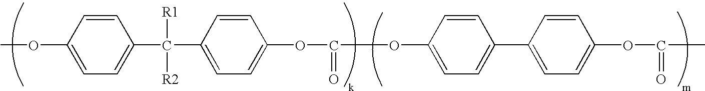 | |
| 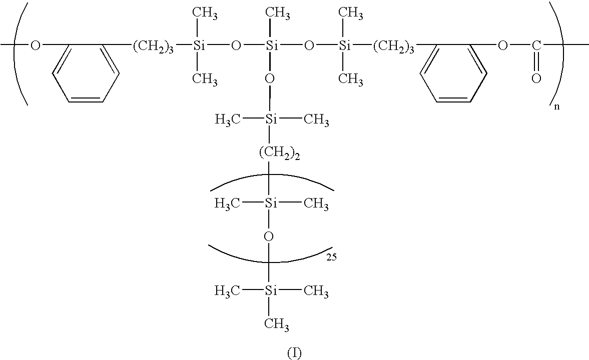 | |
| Silicone oil | 0.002 parts |
| (KF-50 manufactured by Shin-Etsu Chemical Co., Ltd.) | |
| Tetrahydrofuran | 77.4 parts |
| (for use in liquid chromatography, manufactured by Kanto | |
| Chemical Co., Inc.) | |
| Hydroquinone derivative having the formula (IV-2) | 0.014 parts |
| (manufactured by Ricoh Co., Ltd.) | |
| 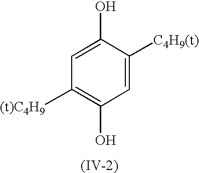 | |
| Hydroquinone derivative having the formula (IV-50) | 0.021 parts |
| (manufactured by Ricoh Co., Ltd.) | |
| 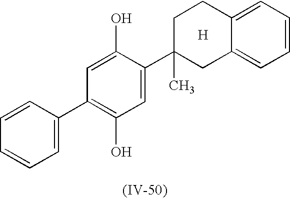 | |

The polycarbonate resin having the formula (I) was prepared

referring to the Example 8 of JP-A 10-182832. The copolymerization ratio (i.e., k, m, and n) was determined by subjecting the resin to ¹H (400 MHz) single pulse method (non-decouple) using an instrument NMR (JNM-A400 manufactured by JEOL Ltd.). The solvent for use in the measurement was heavy dichloromethane (CD₂Cl₂). The viscosity average molecular weight was measured using Ostwald viscometer.

The CTL coating liquid was coated on the charge generation layer by a dip coating method and dried for 15 minutes at 125° C. to prepare a charge transport layer having a thickness of 28 μm.

Thus, a photoreceptor (1) was prepared.

### Example 2

The procedure for preparation of the photoreceptor in Example 1 was repeated except that the copolymerization ratio was changed to as follows: k=0.8, m=0.19, and n=0.01.

Thus, a photoreceptor (2) was prepared.

### Example 3

The procedure for preparation of the photoreceptor in Example 1 was repeated except that the tetrahydrofuran included in the CTL coating liquid was replaced with a tetrahydrofuran including 2,6-di-t-butyl-p-cresol in an amount of 250 ppm.

Thus, a photoreceptor (3) was prepared.

### Example 4

The procedure for preparation of the photoreceptor in Example 3 was repeated except that the amount of the 2,6-di-t-butyl-p-cresol was changed to 500 ppm, and the drying time and temperature of the CTL were changed to 10 minutes and 110° C., respectively.

Thus, a photoreceptor (4) was prepared.

### Example 5

The procedure for formation of the undercoat layer having a thickness of 4.5 μm on the nickel seamless belt in Example 1 was repeated.

A silicone oil (KF-50 manufactured by Shin-Etsu Chemical Co., Ltd.) was added to the CGL coating liquid prepared in Example 1 in an amount of 1% by weight based on the polyvinyl butyral resin, to prepare a CGL coating liquid.

The thus prepared CGL coating liquid was coated on the undercoat layer by a dip coating method and dried for 20 minutes at 130° C. to prepare a charge generation layer having a thickness of 0.07 μm.

Next, the procedure for preparation of the photoreceptor in Example 3 was repeated except that (IV-50) included in the CTL coating layer was replaced with the compound having the formula (IV-43).

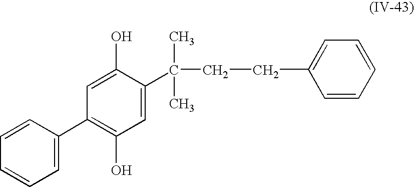

Thus, a photoreceptor (5) was prepared.

### Example 6

The procedure for preparation of the photoreceptor in Example 5 was repeated except that the amount of the silicone oil added to the CGL coating liquid prepared in Example 1 was changed to 0.5% by weight based on the polyvinyl butyral resin, and the amount of the silicone oil added to the CTL coating liquid prepared in Example 1 was changed to 2.5 times that of Example 1.

Thus, a photoreceptor (6) was prepared.

### Example 7

The procedure for preparation of the photoreceptor in Example 3 was repeated except that the CTL coating liquid includes no silicone oil.

Thus, a photoreceptor (7) was prepared.

### Example 8

The procedure for preparation of the photoreceptor in Example 5 was repeated except that the CTL coating liquid includes no silicone oil.

Thus, a photoreceptor (8) was prepared.

### Comparative Example 1

The procedure for preparation of the photoreceptor in Example 1 was repeated except that the drying time and temperature of the CTL were changed to 60 minutes and 140° C., respectively.

Thus, a comparative photoreceptor (C1) was prepared.

### Comparative Example 2

The procedure for preparation of the photoreceptor in Example 1 was repeated except that the drying time and temperature of the CTL were changed to 10 minutes and 90° C., respectively.

Thus, a comparative photoreceptor (C2) was prepared.

### Comparative Example 3

The procedure for preparation of the photoreceptor in Example 1 was repeated except that the polycarbonate resin having the formula (I) was replaced with a bisphenol Z-type polycarbonate resin (TS-2050 manufactured by Teijin Chemicals Ltd., having a viscosity average molecular weight of 50,000).

Thus, a comparative photoreceptor (C30) was prepared.

### Comparative Example 4

The procedure for preparation of the photoreceptor in Example 1 was repeated except that the CTL coating liquid was replaced with the following CTL coating liquid.

| | |
|---|---|
| Charge transport material having the formula (VI) | 7 parts |
| (manufactured by Ricoh Co., Ltd.) | |
| 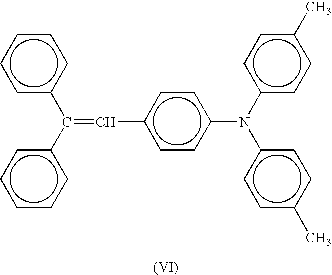 | |
| Polycarbonate resin having the formula (I) | 4 parts |
| (viscosity average molecular weight of 43,000, k = 0.85, | |
| m = 0.149, and n = 0.001) | |
| 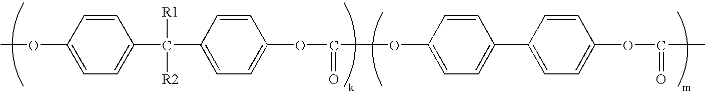 | |
| 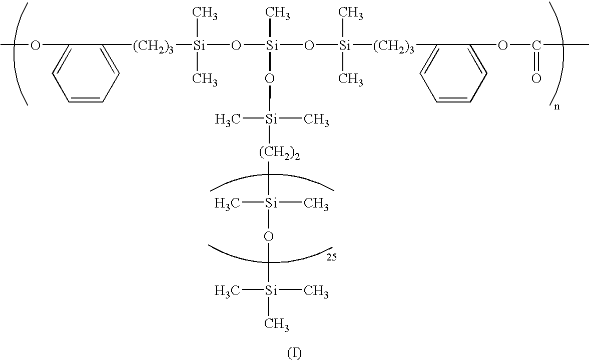 | |
| Bisphenol Z-type polycarbonate resin | 6 parts |
| (TS-2030 manufactured by Teijin Chemicals Ltd.) | |
| Silicone oil | 0.002 parts |
| (KF-50 manufactured by Shin-Etsu Chemical Co., Ltd.) | |
| Tetrahydrofuran | 77.4 parts |
| (for use in liquid chromatography, manufactured by Kanto | |
| Chemical Co., Inc.) | |
| 2,6-di-t-Butyl-4-phenylphenol | 2 parts |

Thus, a comparative photoreceptor (C4) was prepared.

### Comparative Example 5

The procedure for preparation of the photoreceptor in Example 1 was repeated except that the nickel seamless belt having a difference in perimeter between both ends of 0.1 mm was replaced with a nickel seamless belt having a difference in perimeter between both ends of 0.4 mm.

Thus, a comparative photoreceptor (C5) was prepared.

Evaluation

Each of the prepared seamless belt photoreceptors was cut so as to have a length of 367 mm. Guide members made of a urethane rubber having a width of 4 mm and a thickness of 0.7 mm were attached to the backside of the seamless belt 1 mm inside of the both ends.

Next, each of the seamless belt photoreceptors was set to the image forming apparatus illustrated in FIG. 3, together with a driving roller having a diameter of 29 mm and a driven roller having a diameter of 18 mm. The seamless belt was adjusted to have a tension of 30 g/cm. The image forming apparatus illustrated in FIG. 3 had a linear speed of 120 mm/s. The seamless belt photoreceptor was irradiated with a laser light having a wavelength of 780 nm to produce images. Produced images were evaluated as follows.

(1) Image Density Unevenness

The image density unevenness was evaluated by visually observing gray half-tone image formed with the black developing unit. The image density unevenness is graded as follows:
⊚: Very good. No problem in use.
◯: Good. No problem in use.
ΔA: Average. No problem in use.
X: Poor. Not suitable for practical use.
   (2) Black Spots

The number and the shapes of the black spots were evaluated by observing white solid image using a color image processor SPICCA (manufactured by Nippon Avionics Co., Ltd.). Specifically, the white solid image was evaluated by the number of observed black spot having a diameter of 0.05 mm or more, per 1 cm² of the image, and is graded as follows.
⊚: 0
◯: 1 to 2
Δ: 3 to 6
X: 7 or more
   (3) Thin Line Reproducibility

The thin line reproducibility was evaluated by visually observing oblique lines formed with 1-dots, using a loupe to determine whether the dots were reproduced or not. The thin line reproducibility is graded as follows.
⊚: Very good. Dots are reproduced.
◯: Good. Dots are reproduced.
Δ: Average. Dots are collapsed.
X: Poor. Dots are seriously collapsed.
   (4) Fingerprint Resistance

Fingerprint resistance of the prepared seamless belt photoreceptors were evaluated as follows. A fingerprint was made on the seamless belt photoreceptor, and left for a week at a portion of the driven roller having a diameter of 18 mm. Half-tone image was produced after the 1-week left, and the photoreceptor was visually observed whether crack was formed thereon or not. The fingerprint resistance is graded as follows.
⊚: Very good. No problem in use.
◯: Good. No problem in use.
Δ: Average. No problem in use.
X: Poor. Not suitable for practical use.
   (5) Photoreceptor Potential

In order to measure a photoreceptor potential (VL) after the laser beam was irradiated, the revolving developing device 6 was detached from the image forming apparatus and a surface electrometer was attached thereto. The charger 4 was controlled so that non-irradiated portion of the photoreceptor has a potential (VD) of −900 V.

Next, a running test in which 20,000 copies are continuously produced at room temperature and humidity and subsequently 10,000 copies are continuously produced at 30° C. and 90% RH was performed. After the running test, the photoreceptors were subjected to the above-mentioned evaluation again.

In addition, color unevenness was evaluated by visually observing gray half-tone image produced by overlaying yellow image, cyan image, and magenta image. The color unevenness is graded as follows.
⊚: Very good. No problem in use.
◯: Good. No problem in use.
Δ: Average. No problem in use.
X: Poor. Not suitable for practical use.

The amount of the residual solvent in the charge transport layer was determined using an instrument pyrolysis gas chromatograph GC-15A manufactured by Shimadzu Corporation.

The difference in perimeter between both ends of the nickel seamless belt was determined as follows. The nickel seamless belt was tightly stretched with two stainless rollers having an outer diameter of 25.0 mm. One of the stainless rollers was supported with a pair of V blocks and located on the upper side, and the other stainless roller was suspended therefrom due to its own weight. The difference in perimeter between both ends of the nickel seamless belt was determined by measuring the difference in the distance between the stainless roller located on the upper side and that located on the lower side.

In the evaluation of the seamless belt photoreceptor prepared in Comparative Example 5, the guide member arranged on both ends of the backside thereof partially peeled off after 10,000 copies were continuously produced at room temperature and humidity. Consequently, the nickel seamless belt could not be fed, resulting in stopping the evaluation.

The results of the evaluations of the prepared photoreceptors are shown in Table 1.

TABLE 1

| | Before running test | | | | | | | | | | | |
|---|---|---|---|---|---|---|---|---|---|---|---|---|
| | | | | | Image | After running test | | | | | Finger- | Residual |
| | | | Black | Thin line | density | | | Black | Thin line | Color | print | solvent |
| | VD | VL | spots | reproducibility | unevenness | VD | VL | spots | reproducibility | unevenness | resistance | (ppm) |
| Ex. 1 | 910 | 85 | ⊚ | ⊚ | ◯ | 920 | 220 | ◯ | ⊚ | ◯ | ⊚ | 450 |
| Ex. 2 | 895 | 95 | ⊚ | ⊚ | ◯ | 910 | 240 | ⊚ | ⊚ | ◯ | ⊚ | 450 |
| Ex. 3 | 925 | 115 | ⊚ | ⊚ | ◯ | 930 | 220 | ⊚ | ⊚ | ◯ | ⊚ | 450 |
| Ex. 4 | 875 | 105 | ◯ | ⊚ | ◯ | 940 | 270 | ◯ | ◯ | ◯ | ⊚ | 4300 |
| Ex. 5 | 920 | 110 | ⊚ | ⊚ | ⊚ | 930 | 220 | ⊚ | ⊚ | ⊚ | ⊚ | 450 |
| Ex. 6 | 915 | 120 | ⊚ | ⊚ | ⊚ | 930 | 230 | ⊚ | ⊚ | ⊚ | ⊚ | 450 |
| Ex. 7 | 930 | 120 | ◯ | ⊚ | ◯ | 940 | 225 | ◯ | ⊚ | ◯ | Δ | 450 |
| Ex. 8 | 925 | 115 | ⊚ | ⊚ | ◯ | 935 | 235 | ⊚ | ⊚ | ◯ | Δ | 450 |
| Comp. | 935 | 125 | ⊚ | ⊚ | ◯ | 1030 | 285 | ◯ | Δ | ◯ | ⊚ | 12 |
| Ex. 1 | | | | | | | | | | | | |
| Comp. | 905 | 180 | ⊚ | ⊚ | ◯ | 980 | 390 | ◯ | X | ◯ | ⊚ | 5200 |
| Ex. 2 | | | | | | | | | | | | |
| Comp. | 920 | 150 | ⊚ | ⊚ | ◯ | 970 | 290 | ◯ | ◯ | ◯ | X | 1900 |
| Ex. 3 | | | | | | | | | | | | |
| Comp. | 910 | 180 | ⊚ | ⊚ | ◯ | 990 | 340 | ◯ | ◯ | ◯ | X | 2800 |
| Ex. 4 | | | | | | | | | | | | |

This document claims priority and contains subject matter related to Japanese Patent Application No. 2005-250544, filed on Aug. 23, 2005, the entire contents of each of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A photoreceptor, comprising:
an electroconductive substrate; and
a charge transport layer located overlying the electroconductive substrate,
wherein the charge transport layer comprises:
a polydialkylsiloxane-containing polycarbonate resin having the following formula (I): 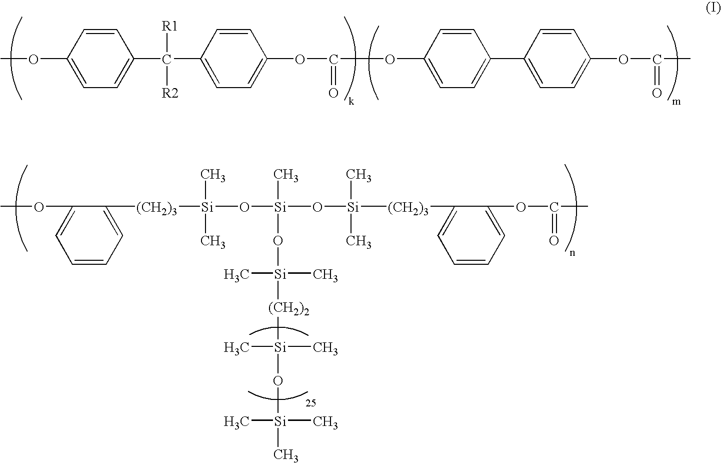
wherein R1 and R2 each, independently, represents a hydrogen atom, a substituted or unsubstituted alkyl group having 1 to 6 carbon atoms, or a substituted or unsubstituted aryl group, wherein R1 and R2 optionally share bond connectivity to form a residue group of a cyclic hydrocarbon having 4 to 10 carbon atoms; and k represents a number of from 0.5 to 0.95, m represents a number of from 0.05 to 0.4999, and n represents a number of from 0.1 to 0.0001, wherein the sum of k, m and n is 1;
a charge transport material; and
a cyclic ether solvent in an amount of from 20 to 5,000 ppm.

2. The photoreceptor according to claim 1, wherein the charge transport layer further comprises plural hydroquinone oxidation inhibitors in a total amount of from 0.05 to 5% by weight based on the charge transport material.

3. The photoreceptor according to claim 1, wherein the charge transport layer further comprises a phenolic oxidation inhibitor.

4. The photoreceptor according to claim 1, in the form of a seamless belt having a difference in perimeter between both ends in a width direction of from 0.05 to 0.31 mm.

5. An image forming apparatus, comprising:
an image bearing member configured to bear an electrostatic latent image;
a developing device configured to develop the electrostatic latent image with at least three toners to form at least three color toner images; and
an intermediate transfer belt contacting the image bearing member, and configured to bear the three color toner images thereon,
wherein the image bearing member is the photoreceptor according to claim 4.

6. The image forming apparatus according to claim 5, further comprising an applicator arranged to apply a metal salt of stearic acid to the intermediate transfer belt and the image bearing member.

7. A process cartridge, detachably attachable to an image forming apparatus, comprising:
an image bearing member; and
at least one member selected from the group consisting of charging means, developing means, cleaning means, and intermediate transfer medium,
wherein the image bearing member is the photoreceptor according to claim 4.
